(19) United States
(12) Patent Application Publication
(10) Pub. No.: US 2022/0029425 A1
(43) Pub. Date: Jan. 27, 2022

(54) ENERGY STORAGE FOR HYBRID MOBILE MICROGRID

(71) Applicant: VOLTAGRID LLC, BELLAIRE, TX (US)

(72) Inventor: Nathan Ough, Bellaire, TX (US)

(73) Assignee: VOLTAGRID LLC, BELLAIRE, TX (US)

(21) Appl. No.: 17/385,579

(22) Filed: Jul. 26, 2021

Related U.S. Application Data
(60) Provisional application No. 63/056,370, filed on Jul. 24, 2020.

(51) Int. Cl. H02J 3/38; H02J 3/32

(52) U.S. Cl. CPC H02J 3/388; H02J 3/32; H02J 2300/10; H02J 2300/20; H02J 3/381

(57) ABSTRACT

An electrical storage system comprising a climate controlled enclosure containing a plurality of battery packs, and an inverter; a coolant system, wherein the coolant system runs through a chiller; and a switchgear, wherein the switchgear has a connector to provide energy to a microgrid.

### BACKGROUND OF THE INVENTION

This disclosure relates in general to microgrids, and in particular, to an energy storage unit for a hybrid mobile microgrid.

In particular, embodiments of the present disclosure includes a complete energy storage system (ESS) that can be permanently mounted on a mobile platform to be transported on a routine basis. The ESS connects to a power supply that provides a charge to the ESS within the limits.

### DESCRIPTION OF PRIOR ART

A microgrid is a self-sufficient energy system that serves a discrete geographic footprint. A microgrid has control capability, which means it can disconnect from the traditional grid and operate autonomously. The microgrid is made up of a decentralized group of electricity sources and loads that normally operate connected to, and synchronous with, the traditional wide area synchronous grid (macrogrid). These electricity sources can also disconnect to “island mode,” where the microgrid operates independently of the macrogrid, and function autonomously as physical or economic conditions dictate. In this way, a microgrid can effectively integrate various sources of distributed generation (DG), especially Renewable Energy Sources (RES), and can supply emergency power, changing between island and connected modes. Mircogrids are also capable of dispatching power to the macrogrid.

Microgrids are best served as localized energy sources, where power transmission and distribution from a major centralized energy source is impractical to implement and/or cost prohibitive.

Generators are frequently used to power microgrids. Generators often require fuel which can result in carbon emissions. Further, generators can typically only bring load on at a certain rate. If the generators call for a greater load this can cause a sag in the voltage through the common bus. This can cause issues on the quality of power provided by the microgrid.

### BRIEF DESCRIPTION OF THE DRAWINGS

The present technology will be better understood on reading the following detailed description of non-limiting embodiments thereof, and on examining the accompanying drawings, in which:

FIG. 1 is a schematic top view of an embodiment of a mobile hybrid micro-grid system, in accordance with embodiments of the present disclosure;

FIG. 2 is a schematic side view of the electrical storage system, in accordance with embodiments of the present disclosure;

FIG. 3 is a schematic side view of the electrical storage system, in accordance with embodiments of the present disclosure;

FIG. 4 is an electrical schematic of the electrical storage system, in accordance with embodiments of the present disclosure;

FIG. 5 is an electrical schematic of the auxiliary power supply of the electrical storage system, in accordance with embodiments of the present disclosure.

### DETAILED DESCRIPTION OF THE INVENTION

The foregoing aspects, features and advantages of the present technology will be further appreciated when considered with references to the following description of preferred embodiments and accompanying drawings, wherein like reference numerals represent like elements. In describing the preferred embodiments of the technology illustrated in the appended drawings, specific terminology will be used for the sake of clarity. The present technology, however, is not intended to be limited to the specific terms used, and it is to be understood that each specific term includes equivalents that operate in a similar manner to accomplish a similar purpose.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments. Additionally, it should be understood that references to “one embodiment”, “an embodiment”, “certain embodiments,” or “other embodiments” of the present invention are not intended to be interpreted as excluding the existence of additional embodiments that also incorporate the recited features. Furthermore, reference to terms such as “above,” “below,” “upper”, “lower”, “side”, “front,” “back,” or other terms regarding orientation are made with reference to the illustrated embodiments and are not intended to be limiting or exclude other orientations.

Various embodiments of the present disclosure utilize a mobile-hybrid microgrid system with an Energy Storage System (ESS). By way of example, the ESS can be permanently mounted on a mobile platform to be transported on a routine basis. In certain embodiments, the ESS connects to a power supply that provides a charge to the ESS within the limits. The power supply could be a single or plurality of generators, utility supply, or a combination thereof. In some embodiments, the ESS can simultaneously charge while it is discharging power.

As discussed in further detail below, an embodiment of a microgrid system may include a switchgear trailer with a common bus. In such a system, the ESS can be connected to the switchgear trailer at any connector with an ESS breaker. The ESS provides supplemental power to the switchgear trailer in a couple ways that other power sources cannot. For example, the ESS can provide supplemental power to the microgrid during transient load phases. When the common bus has a transient load phase this can cause a voltage sag and disruption in the quality of power outputted by the system. The ESS can provide power to the common bus to supplement the common bus to reduce the voltage sag and minimize the effects of the transient load phase. In a similar way, the ESS can function as back up energy storage for the microgrid. In some embodiments, the ESS can be used in power distribution to support line voltage over long distances by connecting ESS units along the distribution line length.

In various embodiments, the ESS is capable of varying the discharge profile from the energy storage system based upon what is required. By way of example, when the switchgear trailer is connected to the grid, the ESS may be used to supplement the microgrid power during load peaking. The ESS system is designed to provide main bus stability during peak load demands, and limit the need for additional generators to be placed online during the intermittent peak loads, thereby reducing the amount of carbon fuel usage. In other embodiments, the ESS may be used to harvest power from the microgrid when power prices are favorable.

The ESS is capable of operating in a variety of applications. For example, the ESS can be used in oil & gas exploration and production activities, such as hydraulic fracturing operations, which are frequently conducted in remote locations without ready access to the macrogrid.

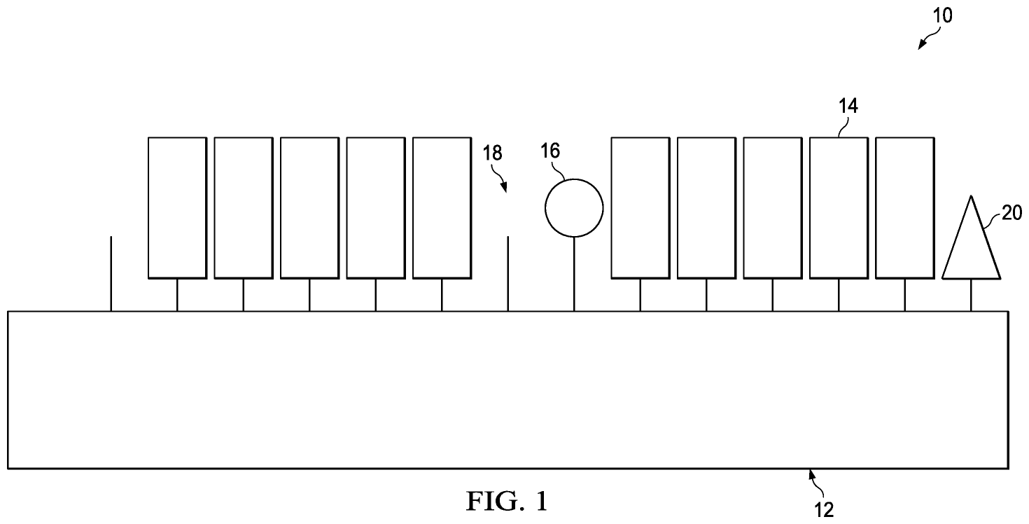

FIG. 1 is a schematic top view of an embodiment of a mobile-hybrid microgrid system 10. The microgrid system includes a mobile switchgear trailer 12. One or more generators 14 are connected to the switchgear trailer 12. In certain embodiments, each generator section includes a 1200 A Circuit breaker, wye/wye PTs, a main bus certified for up to 2000 Amps, a SEL 700 G relay, installation of a pilot wire detection relay, and 15 kV interconnect receptacle for cables. In the illustrated embodiment, a plurality of generators 14 are connected to the switchgear trailer 12. The generators are housed on trailers and can be easily moved and replaced. It should be appreciated that the connections on the switchgear trailer 12 are interchangeable and a different power source could be connected to the switchgear trailer 12 in place of the generator 14. For example, an Energy Storage System (ESS) unit 20 can be connected to the switchgear trailer. In some embodiments a utility section 16 is connected to the switchgear trailer. Each utility section may include a 1200 A Circuit breaker, wye/wye PTs, a main bus certified for up to 2000 Amps, a SEL 700 G relay, installation of a pilot wire detection relay, and 15 kV interconnect receptacle for cables. It should be appreciated that the utility source 16 and ESS unit 20 could be connected to the switchgear trailer 12 at different connections than the ones illustrated in FIG. 1. Additional features show a feeder section 18 connected to the switchgear trailer 12. In certain embodiments, each feeder section includes a 1200 A Circuit breaker, a SEL 700 G relay, installation of a pilot wire detection relay, and 15 kV interconnect receptacle for cables.

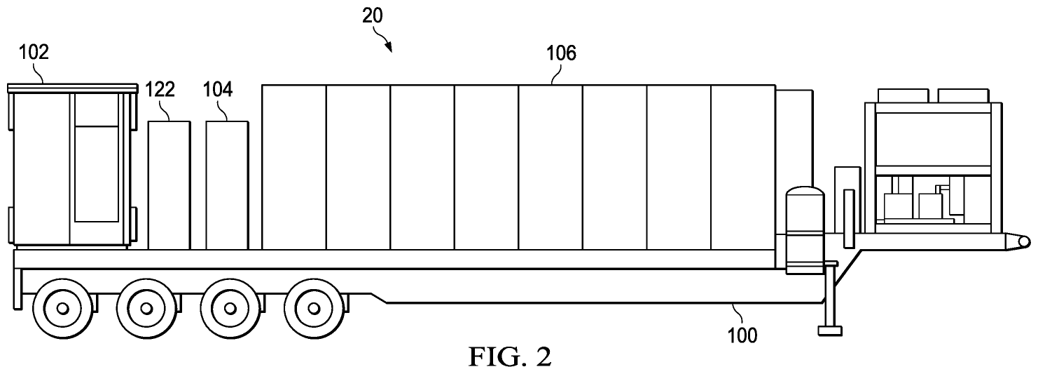

FIG. 2 is a schematic side view of an embodiment of an ESS unit 20 in accordance with one or more embodiments of the present disclosure. In this example, the ESS unit 20 is mounted on a mobile platform 100. In other embodiments, the components of the ESS unit 20 could be mounted on another type of platform, for example a skid. In this embodiment, a transformer 102 is positioned on one end of the ESS unit 20. A switchgear 104 is connected to the transformer 102. Switchgear 104 could be a stackable switchgear, such that two units could be stacked on top of each other. An enclosure 106 is positioned within the ESS unit 20. In some embodiments, enclosure 106 could be a specific duty, steel control house. Within the enclosure 106 is a plurality of battery packs 108.

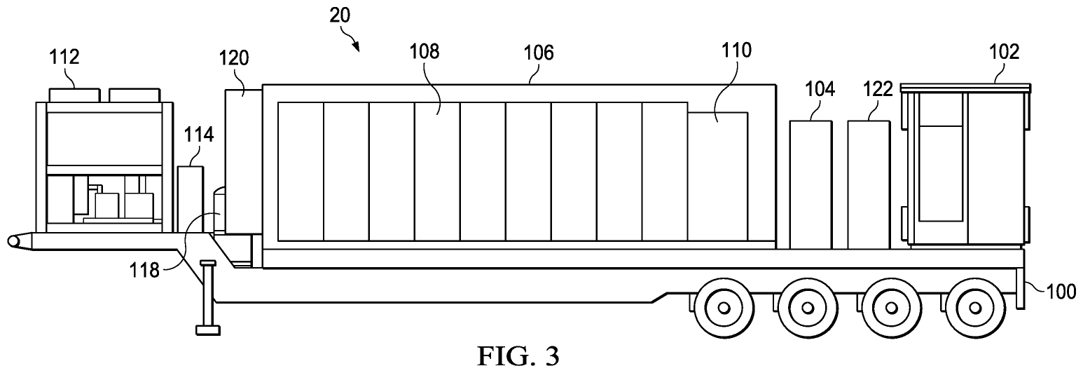

FIG. 3 is a schematic side view of an embodiment of an ESS unit 20 with a cut away on the enclosure 106. In this figure, the battery packs 108 are visible. However, in practice, the battery packs 108 would be fully enclosed within the enclosure 106 with access panels for the battery packs 108 as they are in FIG. 2. In some embodiments, the enclosure 106 may include ten battery packs 108, although more or less than ten could be included. Positioned within the enclosure 106 with the battery packs 108 is inverter 110. Coolant runs between the battery packs 108. In some embodiments, each battery pack is comprised of a plurality of modules. The battery packs are designed in such a manner to allow for flexibility in packaging and retrofit of modules to update equipment. In certain embodiments, there are cooling plates disposed between the modules. The cooling plates contain the coolant. In some embodiments, the coolant is liquid glycol mixture or other types of cooling fluids. The coolant runs between the battery packs 108 to the chiller 112. The chiller 112 extracts the heat from the coolant, which in turn prevents the battery packs 108 from overheating. Positioned on the mobile platform is an auxiliary chilling system 114. The auxiliary chilling system 114 utilizes a cooling system to cool the inverter 110. A surge system 118 is positioned near the chiller 112. The surge system is for the coolant. Attached to the enclosure 106 is an HVAC system 120. The HVAC system 120 maintains a cool dry climate within the enclosure 106. The HVAC system 120 can provide air cooling or air head. The HVAC system 120 can also filter solid particles within the interior of the enclosure 106. In other embodiments cooling of energy storage devices or power electronics can be accomplished with liquid immersion or air cooling. In certain embodiments, the ESS unit 20 includes an auxiliary power outlet such that the ESS unit can be plugged in to charge the ESS unit. In certain embodiments, the ESS unit can provide auxiliary power and includes remote charging ports. In some embodiments, the ESS has shore power connections for charging batteries and to maintain accept temperatures of the energy storage and power electronics. The ESS unit utilizes a control system 122.

The rate of charge and discharge of the ESS is varied by the ESS control system. The control system considers a variety of parameters including: ambient conditions, state of charge, charge/discharge cycle count, storage system lifespan, HVAC constraints, load requirement, and charge power available. The ESS control system is designed to operate “autonomously” meaning the control system is independent from the generator controls and does not have an intrusive interface with the power generation operations. This increases the versatility of the ESS because the ESS can be used in a variety of applications without the hinderance of a complicated interface. In some embodiments, the control system of the ESS is designed to supplement the grid with power when certain parameters are met.

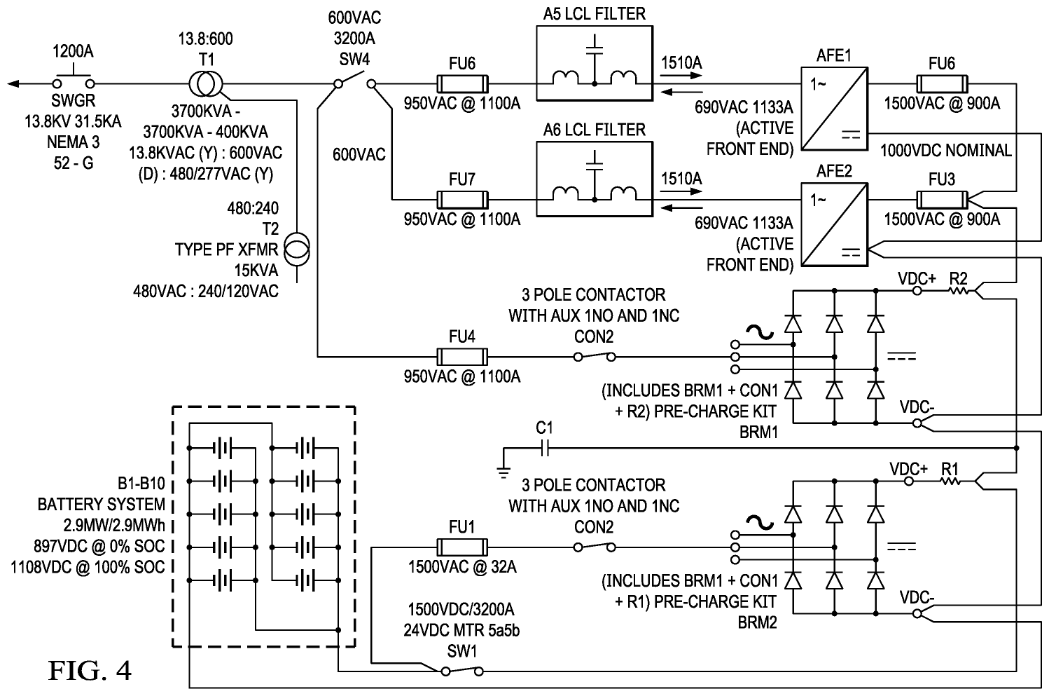

FIG. 4 is an electrical schematic of an embodiment of the ESS unit in accordance with one or more embodiments of the present disclosure. The electrical schematic shows the battery system connected to the inverter. The inverter converts the power from DC to AC. The AC current is then fed into the transformer. The power then flows into the switch gear then feeds the power through a connector into the mobile microgrid. In some embodiments, the connector is a TJB connector. It is possible to divert power from the energy storage system to circumvent the transformer to provide greater variation in AC output voltage from the ESS unit.

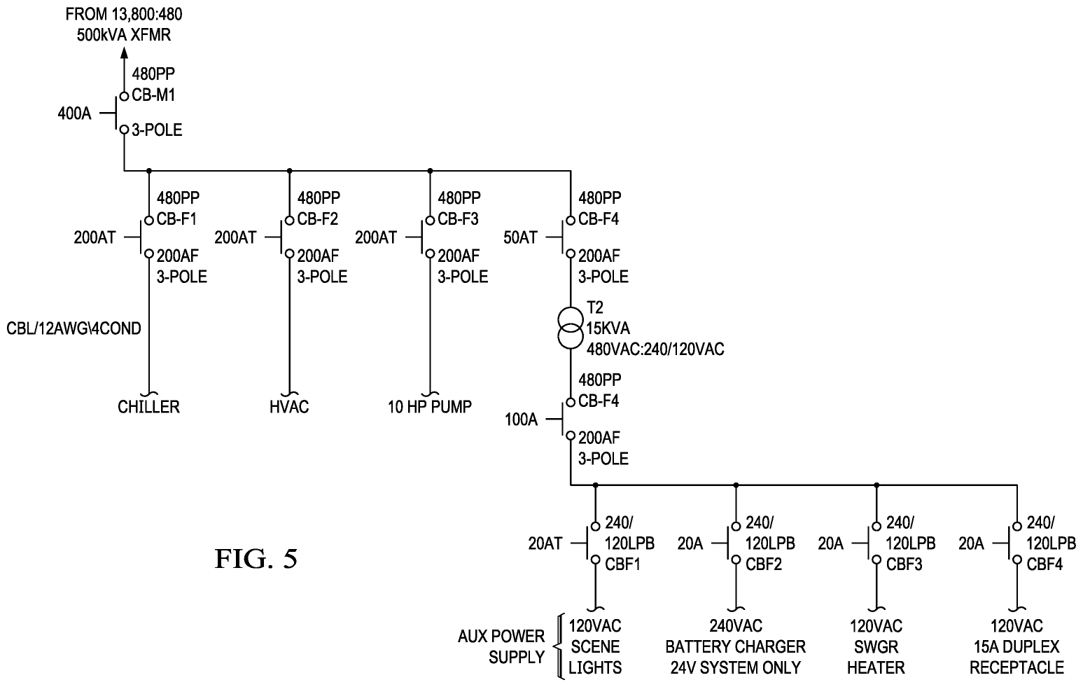

FIG. 5 is an electrical schematic of the auxiliary power supply of the ESS unit in accordance with one or more embodiments of the present disclosure. The auxiliary power supply ensures that the ESS unit is capable of running. For example, the auxiliary power supply powers the lights, the chiller, and the HVAC system.

In certain embodiments, the ESS is designed to operate autonomously from the main power generation system of the microgrid. The ESS is designed to operate autonomously from other ESS units such that one unit can be charging while another is discharging energy. Each battery pack includes its own control that is aggregated into the battery monitoring system which sits on each rack containing the battery pack. The battery monitoring system communicates with the batteries to monitor several parameters including: temperature, DC voltage, state of health, state of charge, depth of discharge, and amplitude of DC current flow with direct of flow. The battery monitoring system can also turn off and on modules within the battery pack. The battery monitoring system for each battery pack is networked into the ESS control system, which controls and monitors all ancillary systems of the trailer. In certain embodiments, the ESS control system can work independently or in unison with the switchgear control system. In certain embodiments the control system can be operated remotely.

The ESS can be connected to any of the input feeders of the microgrid system. The common bus allows for backfeed power to each of the energy sources. The backfeed power enables all the power generation sources to maintain readiness of operation while in a standby state. This readiness of operation allows the power sources to not be operated thereby reducing fuel consumption, operating cost, and overall emissions, when the instance occurs for immediate power required, the power sources can be tuned on immediately to dispatch power to the microgrid. The ESS provides back up power for the load, enables backfeed power to the other power sources attached to the microgrid, enhances the power system stiffness and power quality.

In certain embodiments, the ESS can include a fire system. For example, the ESS can include a gas fire system that is rated for lithium stored energy systems. An automated internal flame sensor can be installed with an audible and klaxon warning that can discharge to put the fire out. Internal motion sensors can be present to determine if the ESS is occupied. One manually operated discharge activator can be installed near each of the two entry doorways into the ESS.

In certain embodiments, the ESS can be used as voltage support on a distribution line. In this embodiment, an ESS can be positioned along the distribution line and provide voltage support when a voltage drop is detected. It would be understood that a plurality of ESS units could be positioned along the distribution line to provide voltage support.

Although the technology herein has been described with reference to particular embodiments, it is to be understood that these embodiments are merely illustrative of the principles and applications of the present technology. It is therefore to be understood that numerous modifications may be made to the illustrative embodiments and that other arrangements may be devised without departing from the spirit and scope of the present technology as defined by the appended claims.

1. A electrical storage system comprising:
a climate controlled enclosure containing:
a battery pack;
an inverter;
a coolant system, wherein the coolant system runs through a chiller; and
a switchgear, wherein the switchgear has a connector to provide energy to a microgrid.

2. The electrical storage system of claim 1, wherein the coolant system contains cooling fluid.

3. The electrical storage system of claim 2, wherein the cooling fluid is liquid glycol.

4. The electrical storage system of claim 1, wherein the switchgear is a stackable switchgear.

5. The electrical storage system of claim 1, wherein the system is mounted on a mobile trailer.

6. The electrical storage system of claim 1, wherein the connector is a TJB connector.

7. The electrical storage system of claim 1, wherein there are a plurality of battery packs.

8. The electrical storage system of claim 7, wherein there are at least ten battery packs.

9. The electrical storage system of claim 1, wherein the battery packs are charged by a renewable energy source.

10. The electrical storage system of claim 1, wherein the battery packs are charged by a generator.

11. The electrical storage system of claim 1, wherein the battery packs are charged by a utility source.

12. The electrical storage system of claim 1, wherein the system is designed to operate autonomously.

13. An electrical storage system comprising:
a climate controlled enclosure containing:
a plurality of battery packs;
an inverter;
a switchgear comprising a connecter to provide energy to a microgrid; and
a transformer.

14. The electrical storage system of claim 13, wherein the system is configured to charge and discharge power directly from the inverter and circumvent the transformer.

15. The electrical storage system of claim 13, wherein the system is configured to operate independently of a microgrid.

16. The electrical storage system of claim 15, wherein the system is capable of providing voltage support along a distribution line.

17. The electrical storage system of claim 13, wherein the system has a shore power connection.

18. The electrical storage system of claim 13, wherein the system is configured to charge and offload power simultaneously.

19. The electrical storage system of claim 13, further comprising a control system configured to supplement power to the microgrid when certain parameters are met.
